(19) United States
(12) Patent Application Publication
(10) Pub. No.: US 2014/0088927 A1
(43) Pub. Date: Mar. 27, 2014

(54) SYSTEMS AND METHODS FOR SIMULATION OF VIRTUAL MODEL

(71) Applicant: SIEMENS PRODUCT LIFECYCLE MANAGEMENT SOFTWARE, Plano, TX (US)

(72) Inventors: Julu Cao, Shanghai (CN); Karen Shi, Shanghai (CN); Matthias Lenord, Fountain Valley, CA (US); Xiaoxiang Shi, Irvine, CA (US)

(73) Assignee: SIEMENS PRODUCT LIFECYCLE MANAGEMENT SOFTWARE INC., Plano, TX (US)

(21) Appl. No.: 13/629,336

(22) Filed: Sep. 27, 2012

(51) Int. Cl. G06F 17/50

(52) U.S. Cl. 703/1

(57) ABSTRACT

Systems and methods for simulation of a virtual model. The system is configured to generate a first data representing the virtual model and transform the first data to a feedback data using one or more mapping functions. The system is configured to generate by a programmable controller a plurality of output data responsive to the feedback data and apply the output data to the virtual model to effect change to the virtual model. The method includes generating a first data representing the virtual model and transforming the first data to a feedback data using one or more mapping functions. The method includes generating by an external programmable controller an output data responsive to the feedback data and applying the output data to the virtual model to effect change to the virtual model.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or “PDM” systems).

### BACKGROUND OF THE DISCLOSURE

PDM systems manage PLM and other data. Improved systems are desirable.

### SUMMARY OF THE DISCLOSURE

Various disclosed embodiments include systems and methods for simulation virtual models. According to disclosed embodiments, the system includes at least one processor, a memory connected to the processor, a communication network, and an external programmable controller connected to the processor via the communication network. The system is configured to generate a first data representing the virtual model and transform the first data to a feedback data using one or more mapping functions. The system is configured to generate by the programmable controller a plurality of output data responsive to the feedback data and apply the output data to effect change to the virtual model. According to disclosed embodiments, the method includes generating a first data representing the virtual model and transforming the first data to a feedback data using one or more mapping functions. The method includes generating by an external programmable controller an output data responsive to the feedback data and applying the output data to effect change to the virtual model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system according to disclosed embodiments;

FIG. 2 illustrates a PDM system according to disclosed embodiments;

FIG. 3 illustrates a PDM system according to other disclosed embodiments;

FIGS. 4-6 illustrate modifications of a virtual model in accordance with disclosed embodiments;

FIGS. 7-9 illustrate operation of a PDM system in accordance with disclosed embodiments;

FIG. 10 is a flowchart of a process according to disclosed embodiments;

FIG. 11 is a flowchart of a process according to other disclosed embodiments; and

FIG. 12 illustrates a cloud computing system according to disclosed embodiments.

### DETAILED DESCRIPTION

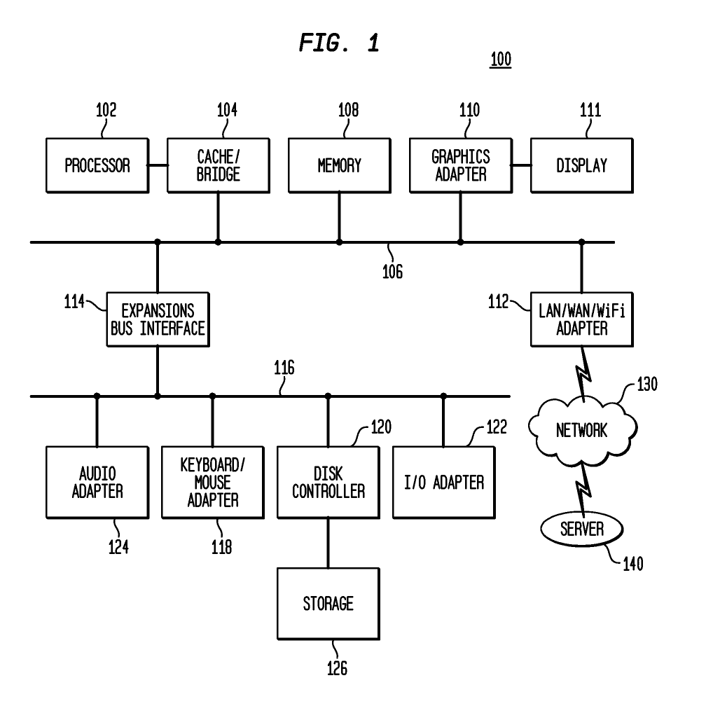

FIGS. 1 through 12, discussed below, and the various embodiments used to describe the principles of the present disclosure in this patent document are by way of illustration only and should not be construed in any way to limit the scope of the disclosure. Those skilled in the art will recognize that the principles of the present disclosure may be implemented in any suitably arranged device or a system. The numerous innovative teachings of the present disclosure will be described with reference to exemplary non-limiting embodiments

PDM systems are widely used in design, development and modification of products and systems. PDM systems allow designers and engineers to develop and test products in a virtual environment prior to building actual prototypes. Advances in PDM technology enable virtual validation of products by creating and testing computer-implemented models. Virtual validation of products allows designers and engineers to verify functionalities and identify potential defects in the products.

Currently available PDM systems, for example, allow users to define and assemble virtual devices into a virtual system. The virtual system may be connected to an external programmable logic controller. A user utilizes a virtual control panel or a virtual switchboard in a workstation to access the virtual devices from a device library. There are drawbacks associated with currently available systems. A user, for example, typically must use a virtual control panel to assemble a model and also to modify the model.

Various disclosed embodiments provide systems and methods for interactive simulation of a computer-implemented virtual model. The disclosed embodiments allow a user to directly make modifications to a virtual model without the aid of a virtual control panel and to simulate the response of the model. Consequently, potential defects in a product may be identified and the product may be validated in less time, thus decreasing the product's development time.

FIG. 1 depicts a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are main memory 108 and graphics adapter 110. Graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

The data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a workstation, and a plurality of similar workstations may be linked via a communication network to form a distributed system in accordance with embodiments of the disclosure.

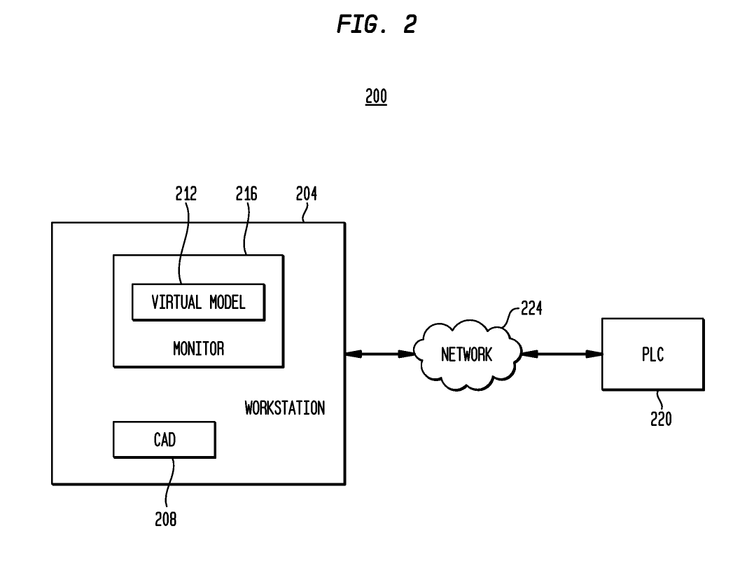

FIG. 2 illustrates PDM system 200 according to disclosed embodiments. PDM system 200 comprises computer workstation 204 including CAD application 208. Workstation 204 may be implemented by data processing system 100 as described above. A user utilizes CAD application 208 to create virtual model 212 which may be graphically displayed on monitor 216 connected to workstation 204. The user may connect virtual model 212 to external programmable logic controller 220 via communication network 224 to test and validate the model. Controller 220 may be implemented in software or hardware. In other embodiments, controller 220 may be directly connected to virtual model 212 via, for example, a USB port.

According to disclosed embodiments, the user may directly make changes to model 212 without the aid of a virtual control panel and simulate the response of controller 220. The user may, for example, inject error signals to model 212 to simulate the controller's response.

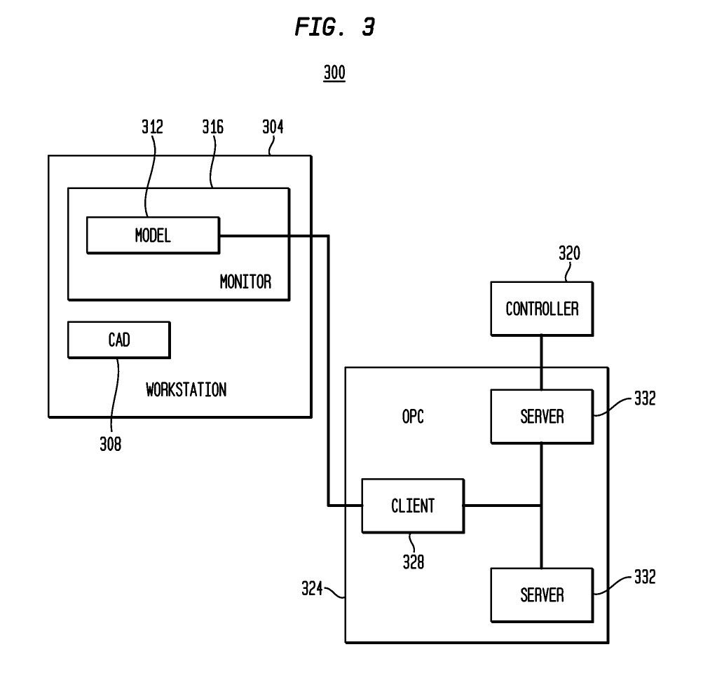

FIG. 3 illustrates PDM system 300 according to other disclosed embodiments. PDM system 300 comprises workstation 304 including CAD application 308. A user creates virtual model 312 using CAD application 308, which may be displayed on monitor 316. According to disclosed embodiments, virtual model 312 may be connected to controller 320 via open process control (OPC) layer 324. It will be understood by those skilled in the art that OPC layer 324 is implemented in accordance with OPC standards, which enable interoperability among automation control applications, field systems, devices, and business applications. Applications implemented in different platforms may utilize open data exchange specifications of OPC layer 324 to create, test and validate virtual models. According to disclosed embodiments, OPC layer 324 may be implemented using Microsoft's Component Object Model (COM) and Distributed COM applications.

Referring to FIG. 3, according to disclosed embodiments, OPC layer 324 may comprise OPC client 328 connected to one or more OPC server 332. OPC client 328 facilitates data flow between virtual model 312 and OPC server 332 while OPC server 332 facilitate data flow between controller 320 and OPC client 328, thus enabling communication between controller 320 and virtual model 312. Workstation 304, OPC layer 324 and controller 320 may be interconnected via a communication network such as the Internet (not shown in FIG. 3).

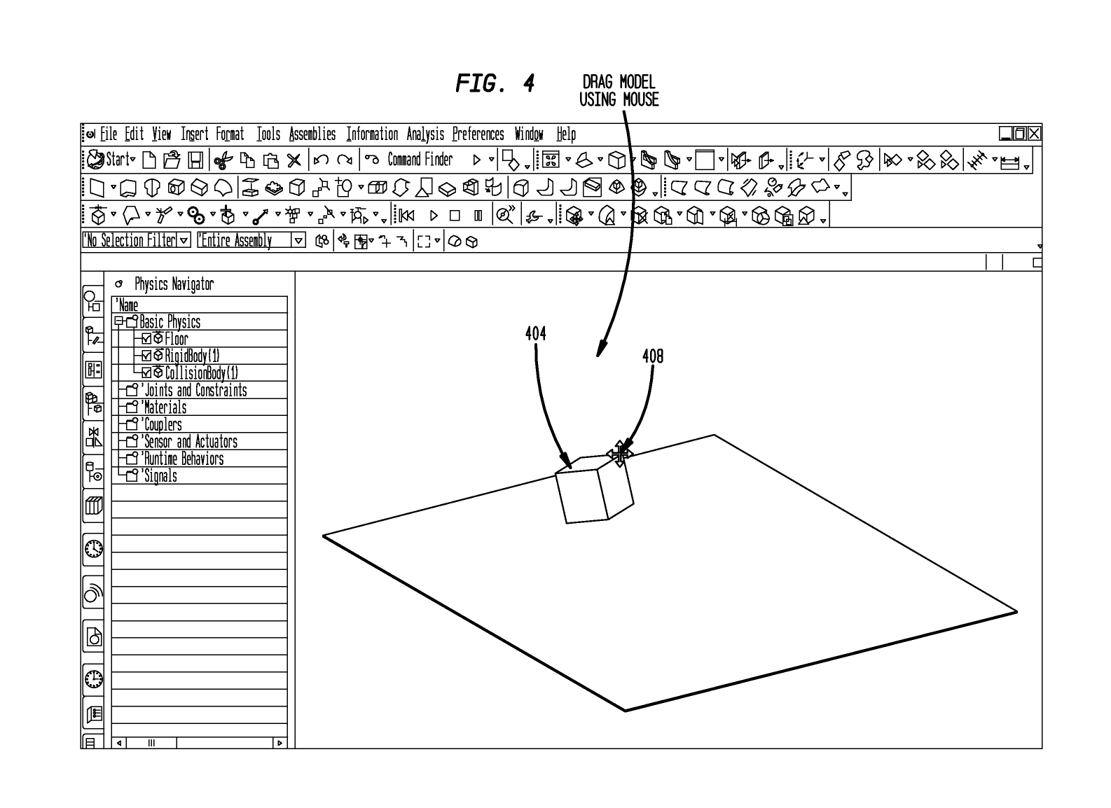

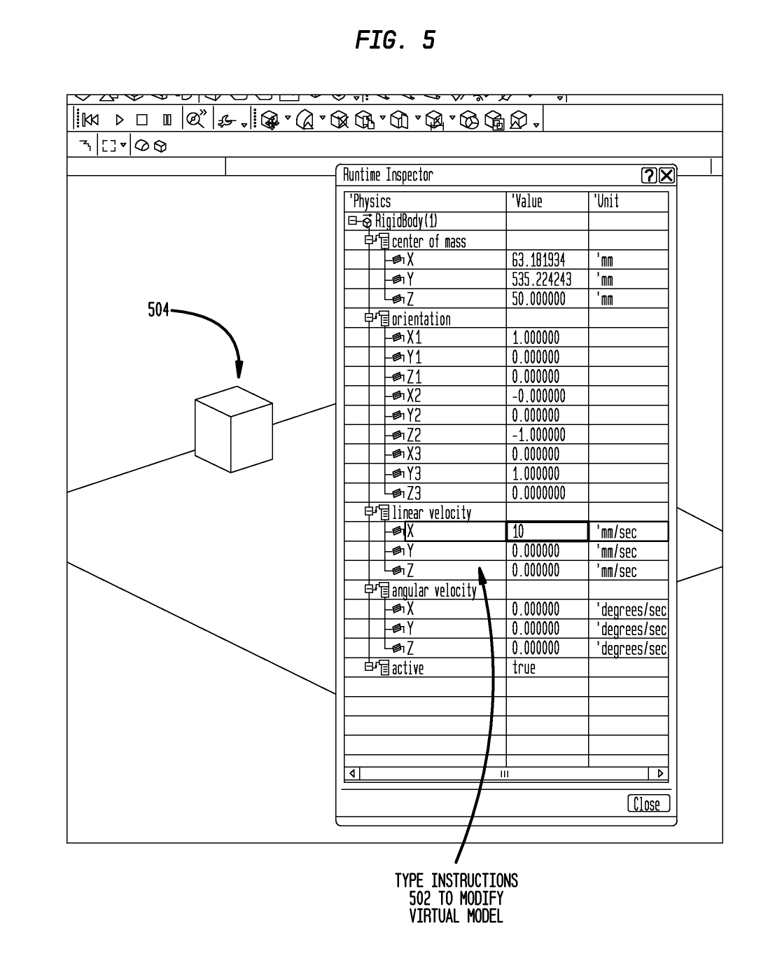

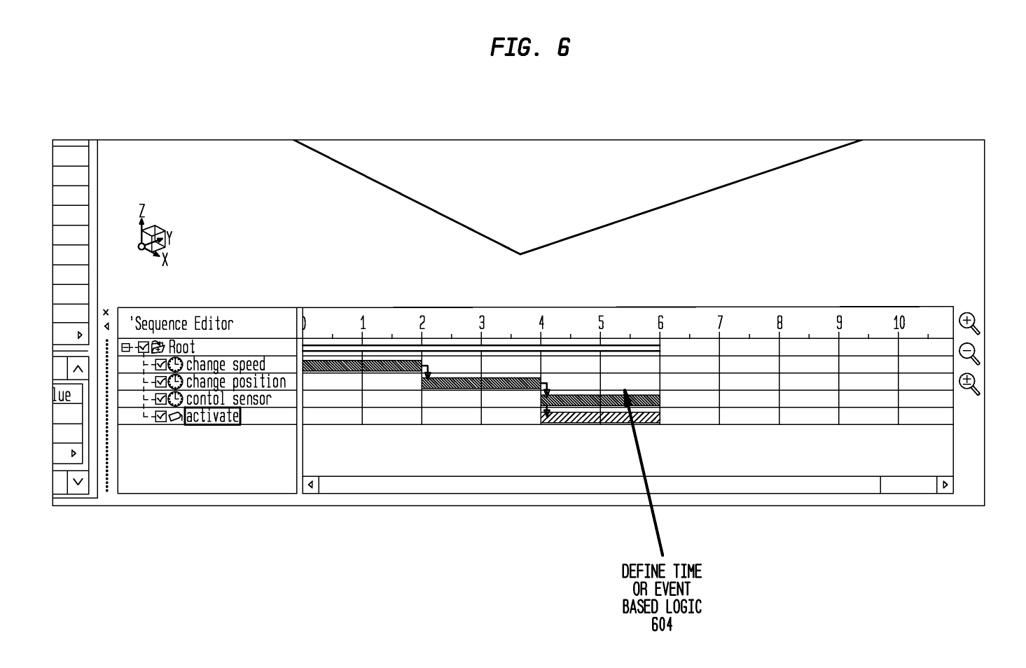

According to disclosed embodiments, PDM system 300 enables a user to directly interact with virtual model 312 without the aid of a virtual control panel. The user, for example, may inject error signals into the virtual model to simulate the response of controller 320. FIGS. 4-6 illustrate modifications of a virtual model in accordance with disclosed embodiments. A user may move virtual model 404 by using a mouse (not shown) to drag handle 408 as shown in FIG. 4. Also, as shown in FIG. 5, a user may type in instructions 502 to make modifications to virtual model 504. Also, as shown in FIG. 6, a user may graphically define an algorithm 604 to simulate a time-based or an event-based response.

According to disclosed embodiments, a user may test and validate a virtual model by connecting controller 320 to OPC layer 324. Controller 320 may be a physical or a virtual programmable logic controller (PLC) with a human machine interface (HMI). The user may configure signals in the virtual model to enable signals/data flow between the OPC layer and the CAD system. By way of example, signals representing a sensor trigger and start/stop time of a motor may be configured. The flow of signals/data may be bi-directional (e.g., transfer position of the door to one OPC signal, and transfer one OPC signal to the speed of motor).

Next, the user may start controller 320, which runs the virtual model to simulate a closed-loop system. The user may interact with the virtual model by adding control logic and triggers or by injecting errors. The injected errors are transferred to controller 320 via OPC layer 324 to simulate the controller's response. The interactive error injection mechanism allows the user to inject errors dynamically during execution. The injected errors can be correctable, uncorrectable, or fatal errors.

Consider, for example, a virtual model of a closed-loop control system featuring a mechanical contactor. If a controller sends a command to close the contactor, under normal operating conditions, the contactor returns a feedback signal to indicate that the contactor has been closed. If the contactor fails to return a feedback signal within a specified time period, the controller sends a warning signal.

According to disclosed embodiments, a user may implement PDM system 300 to validate a virtual model of a closed-loop system featuring a mechanical contactor. In the virtual model, a sensor may be attached to an auxiliary contactor to sense the status of the contactor and to return a feedback signal. The user may disconnect or disable the sensor, or drag the sensor to a new position, thus injecting errors into the virtual model to determine whether the controller is responding properly by generating a warning signal and correcting the error. According to disclosed embodiments, various properties of the virtual model may be defined. For example, a rotation speed of a motor may be defined by a floating point number while the motor's start, end, and direction of rotation (e.g., forward, reverse) may be defined by Boolean logic. According to disclosed embodiments, the closed-loop system may be simulated to operate at a high frequency (e.g., 2 milliseconds per simulation step).

According to disclosed embodiments, PDM system 300 provides an interactive simulation environment capable of responding to dynamic situations. A user can visualize system response to injected errors, thus detecting design problems. The errors may be injected using a user-friendly interface during execution. For example, the user may drag a movable object by holding the cursor over it. The drag action is identified and converted to a signal whose value is determined by the distance traversed by the cursor. The user may also modify the speed of a motor or position of an object by, for example, dragging a block to a light-barrier.

According to disclosed embodiments, objects in the virtual model may be modified and controls may be activated or deactivated. Also, a connection of a signal between any object and the controller can be broken, thus injecting an error.

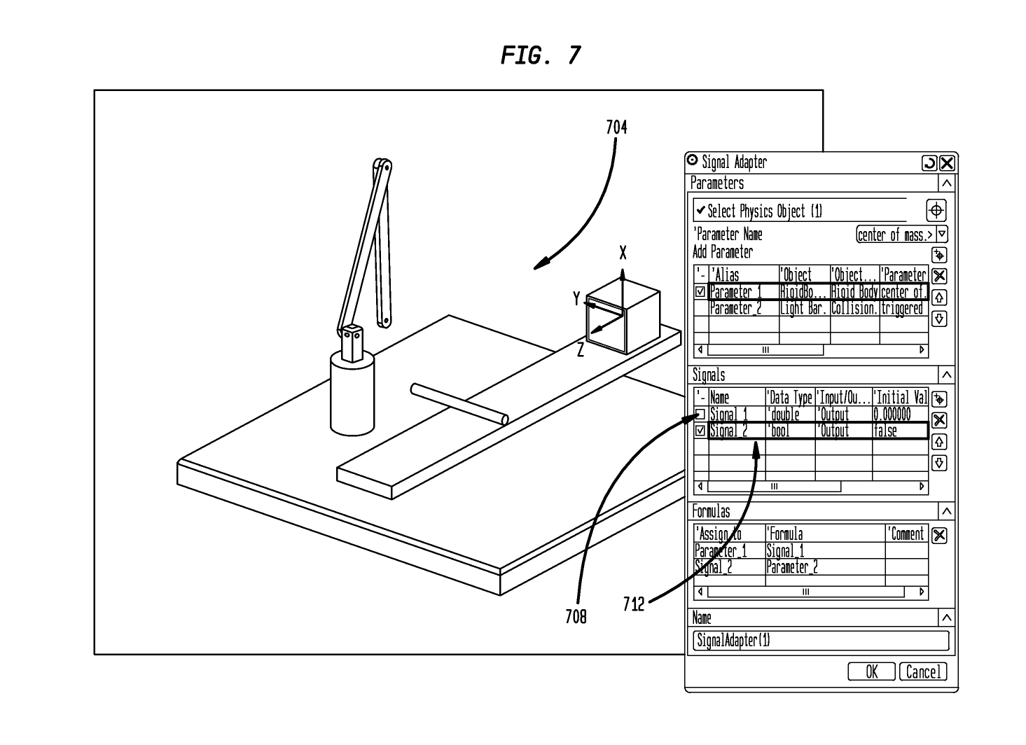

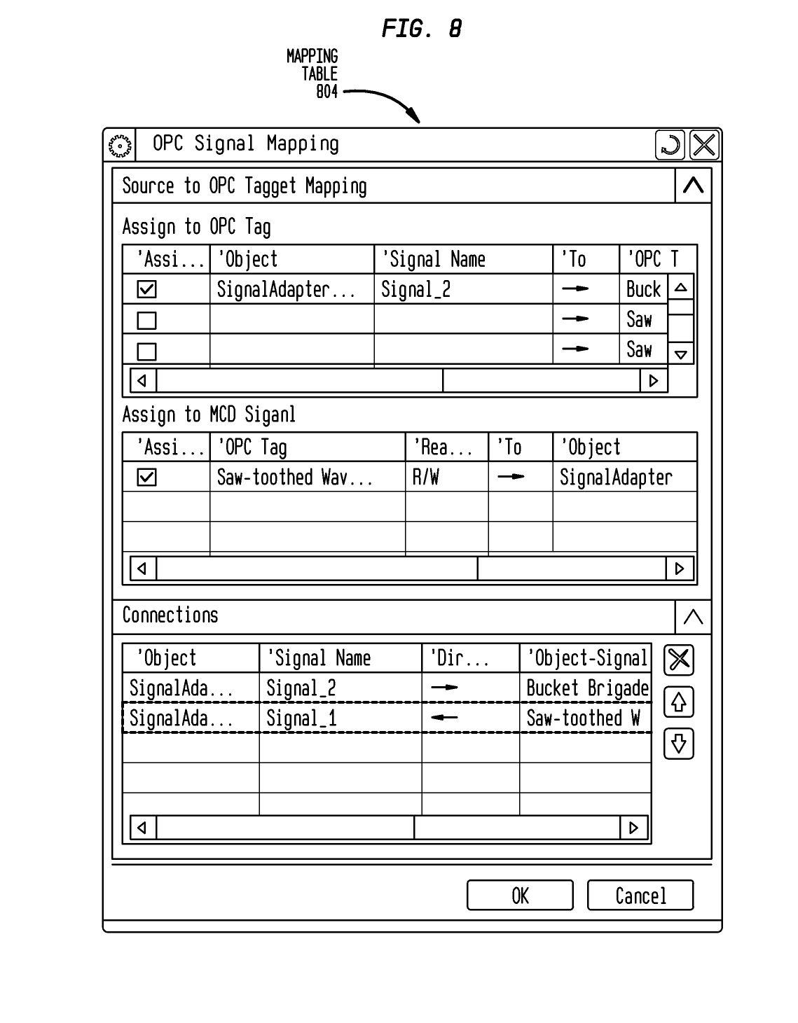

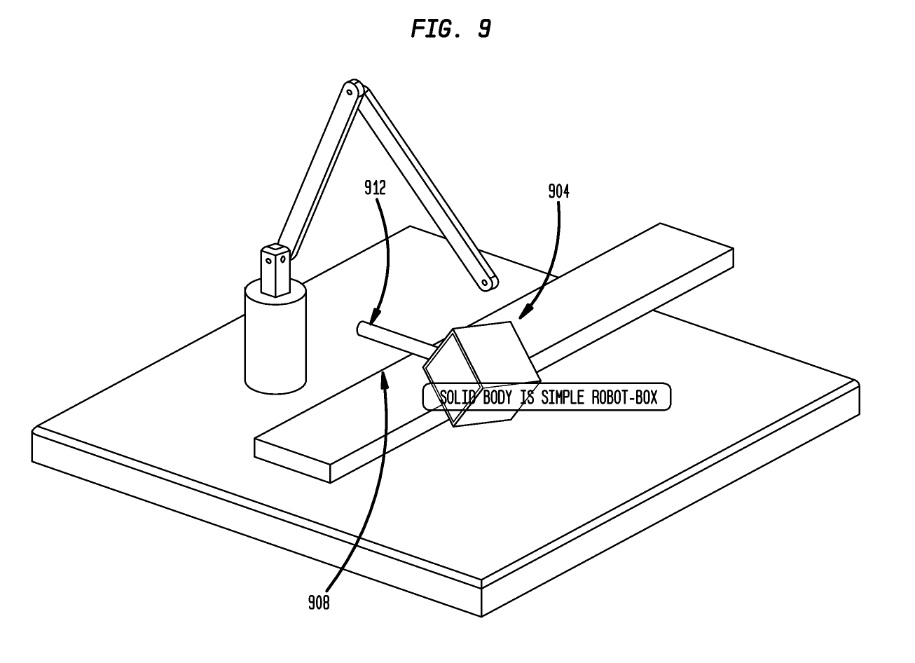

FIGS. 7-9 illustrate operation and use of PDM system 300 in accordance with disclosed embodiments. As shown in FIG. 7, one or more signals representing virtual model 704 are defined. By way of example, in FIG. 7 two signals representing virtual model 704 may be defined: first signal 708 defining the position of a block on a transport belt and second signal 712 defining the trigger status of a sensor attached to a light barrier. The signals may be represented by one or more polynomials and/or data. Next, the defined signals are configured and mapped using mapping table 804 as shown in FIG. 8. The mapped signals may be referred to as feedback signals. The feedback signals are transmitted to OPC layer 324 which in turn transmits the feedback signals to controller 320. The mapping table in FIG. 8 may transform a stream of signals, which are transmitted to OPC layer 324. Referring to FIG. 9, the user may drag block 904 to light barrier 908, triggering sensor 912. In response, controller 320 generates one or more output signals which are applied to virtual model 312 via OPC layer 324. It will be appreciated that application of the output signals to virtual model 312 effects change to virtual model 312. The feedback signals and the output signals may be represented by one or more polynomials and/or data.

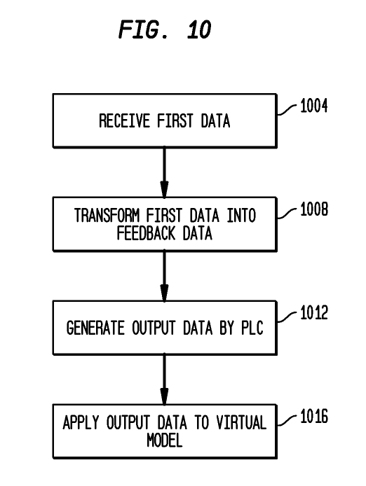

FIG. 10 is a flowchart of a process according to disclosed embodiments. Such a process can be performed, for example, by system 300 as described above, but the “system” in the process below can be any apparatus configured to perform a process as described.

In block 1004, system 300 receives first data representing a virtual model. According to disclosed embodiments, the first data may be provided by a device library.

In block 1008, one or more mapping functions transform the first data into feedback data. According to embodiments, a mapping table including mapping functions may be used to transform the first data into the feedback data.

In block 1012, an external programmable logic controller generates output data responsive to the feedback data. The external programmable logic controller may be implemented in software or hardware. As described before, an OPC layer may be implemented to facilitate data flow between system 300 and the external programmable logic controller.

In block 1016, system 300 applies output data to the virtual model to effect change. As described before, the modification of the virtual model causes modification of the first data representing the model. The modified first data may be stored in a workstation and the modified virtual model may be displayed on a monitor.

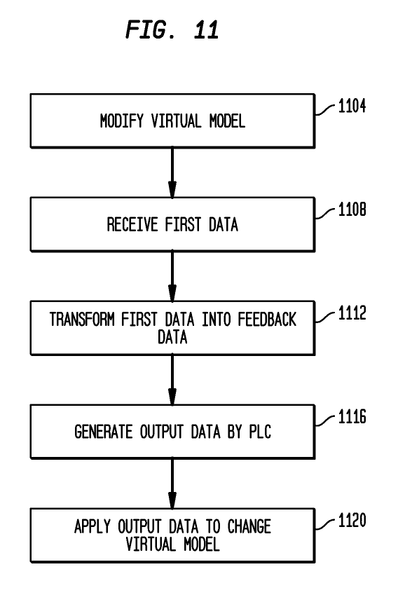

FIG. 11 is a flowchart of a process according to other disclosed embodiments. In block 1104, system 300 modifies the virtual model. By way of example, the virtual model may be modified by injecting error signals to the model or by changing the position of the virtual model on a monitor.

In block 1108, system 300 receives first data representing the modified virtual model. As described before, the first data may be provided by a device library.

In block 1112, one or more mapping functions transform the first data into feedback data. According to embodiments, a mapping table including mapping functions may be utilized to transform the first data into the feedback data.

In block 1116, an external programmable controller generates output data responsive to the feedback data. The external programmable logic controller may be implemented in software or hardware. As described before, an OPC layer may be implemented to facilitate data flow between system 300 and the external programmable controller.

In block 1120, system 300 applies the output data to effect change in the virtual model. The modified virtual model may be stored in a workstation.

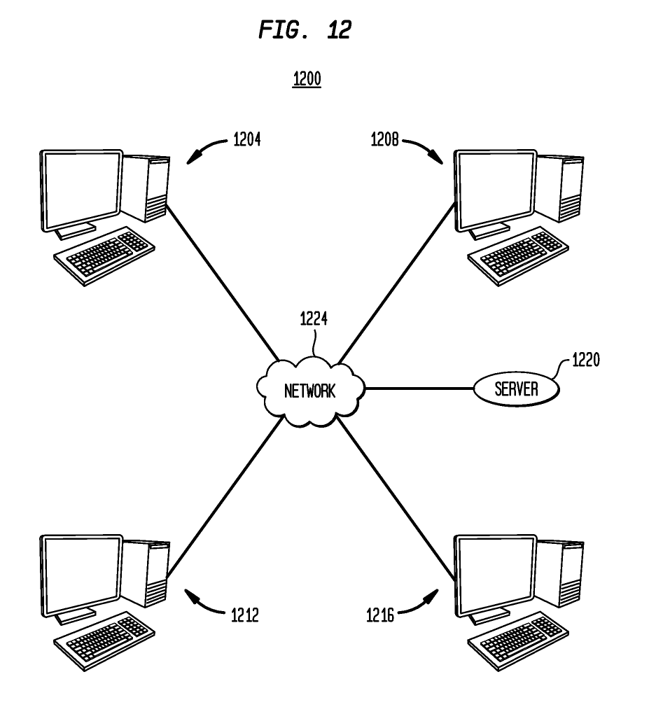

FIG. 12 illustrates a cloud computing system 1200 according to disclosed embodiments. System 1200 includes plurality of workstations 1204-1216 linked to server 1220 via a communication network such as the Internet 1224. Server 1020 may be implemented as system 300, which enables workstations 1204-1216 to create, modify and simulate a virtual model. By way of example, workstation 1204 may create and simulate a virtual model which is stored in the server 1220.

According to embodiments, a non-transitory computer-readable medium is encoded with computer-executable instructions for interactive simulation of a virtual model. The computer-readable medium includes instructions for generating first data representing the virtual model and for transforming the first data to a feedback data using one or more mapping functions. The computer-readable medium includes instructions for generating output data responsive to the feedback data and for applying the output data to effect change to the virtual model.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A data processing system for simulation of a computer-implemented virtual model, comprising:
at least one processor;
a memory connected to the processor;
a communication network; and
an external programmable controller connected to the processor via the communication network, the data processing system configured to
generate a first data representing the virtual model;
transform the first data to a feedback data using one or more mapping functions;
generate by the programmable controller a plurality of output data responsive to the feedback data, wherein the programmable controller includes program code for generating the output data; and
apply the output data to the computer-implemented model to effect change to the virtual model.

2. The data processing system of claim 1, further comprising an open process control server connected to the communication server, the open process control server configured to receive the feedback data from the processor and to transmit the feedback data to the external programmable controller.

3. The data processing system of claim 1, further comprising an open process control server configured to receive output data from the external programmable controller and to transmit the output data to the processor.

4. The data processing system of claim 1, wherein the processor is configured to generate modification commands specifying portions of the first data to be modified to effect change to the virtual model.

5. The data processing system of claim 1, further comprising a monitor connected to the memory for graphically displaying the virtual model, wherein changing the position of the virtual model on the monitor modifies the first data.

6. The data processing system of claim 5, wherein changing the position of the virtual model on the monitor modifies the output data.

7. The data processing system of claim 1, wherein the first data is represented by a plurality of first functions.

8. The data processing system of claim 1, wherein the feedback data is represented by a plurality of feedback functions.

9. The data processing system of claim 1, wherein the output data is represented by a plurality of output functions.

10. The data processing system of claim 1, wherein the external programmable controller is implemented in software.

11. The data processing system of claim 1, wherein the external programmable controller is implemented in hardware.

12. A method for interactive simulation of a computer-implemented virtual model, comprising:
generating a first data representing the virtual model;
transforming the first data to a feedback data using one or more mapping functions;
generating by an external programmable controller an output data responsive to the feedback data, wherein the programmable controller includes program code for generating the output data; and
applying the output data to the virtual model to effect change to the virtual model.

13. The method of claim 12, wherein application of the output data to the virtual model modifies the first data.

14. The method of claim 12, further comprising:
receiving by an open process control server over a communication network the feedback data; and
transmitting by the open process control server over the communication network the feedback data to the external programmable controller.

15. The method of claim 12, further comprising:
storing the first data representing the virtual model in a memory;
graphically displaying the virtual model on a monitor connected to the memory; and
changing the position of the virtual model on the monitor, wherein a change of the position of the virtual model modifies the first data.

16. The method of claim 15, wherein changing the position of the virtual model on the monitor modifies the output data.

17. A non-transitory computer-readable medium encoded with computer-executable instructions for interactive simulation of a computer-implemented virtual model, wherein the computer-executable instructions when executed cause at least one data processing system to:
generate a first data representing the virtual model;
transform the first data to a feedback data using one or more mapping functions;
generate by an external programmable controller an output data responsive to the feedback data, wherein the programmable controller includes program code for generating the output data; and
apply the output data to the virtual model to effect change to the virtual model.

18. The computer-readable medium of claim 17, wherein the computer-executable instructions when executed cause the data processing system to:
store the first data representing the virtual model in a memory;
graphically display the virtual model on a monitor connected to the memory; and
change the position of the virtual model on the monitor, wherein a change of the position of the virtual model modifies the first data.

19. The computer-readable medium of claim 18, wherein the virtual model is graphically displayed on a monitor, and wherein changing the position of the virtual model on the monitor modifies the first data.

20. The computer-readable medium of claim 18, wherein changing the position of the virtual model on the monitor modifies the output data.
